(19) United States
(12) Patent Application Publication
(10) Pub. No.: US 2026/0361030 A1
(43) Pub. Date: Nov. 12, 2026

(54) PUSH/PUSH MALE/FEMALE CABLE CONNECTOR SYSTEM

(71) Applicant: Dell Products L.P., Round Rock, TX (US)

(72) Inventors: Yayun Liu, Austin, TX (US); Neal Beard, Austin, TX (US); Padmanabhan Narayanan, Chennai (IN)

(21) Appl. No.: 19/202,150

(22) Filed: May 8, 2025

(51) Int. Cl. H01R 13/629

(52) U.S. Cl. CPC H01R 13/629

(57) ABSTRACT

A push/push male/female cable connector system includes a male cable connector subsystem having a male cable connector, and a computing device having a female cable connector subsystem that includes a female cable connector and a push/push securing mechanism. The push/push securing mechanism on the female cable connector subsystem engages the male cable connector subsystem when it is moved a securing distance into the female cable connector subsystem, which secures the male cable connector subsystem in the female cable connector subsystem in a secured orientation in which the male cable connector is connected to the female cable connector. The push/push securing mechanism on the female cable connector subsystem disengages the male cable connector subsystem when it is moved from the secured orientation and a release distance into the female cable connector subsystem, which releases the male cable connector subsystem from the female cable connector subsystem.

### BACKGROUND

The present disclosure relates generally to information handling systems, and more particularly to a push/push male/female cable connector system for connecting cables to information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, networking devices (e.g., switch devices), server devices, storage systems, and/or other computing devices known in the art, are connected using cables in order to enable the transmission of data and/or other communications between those computing devices. The cables discussed above typically include a male cable connector that is connected to a female cable connector included on the computing devices. For example, Ethernet cables are provided with RJ45 male cable connectors that include a latch that is configured to engage a retainer on an RJ45 female cable connector on a computing device when the RJ45 male cable connector is inserted in the RJ45 female cable connector to secure the Ethernet cable to the computing device. Similarly, Direct Attach Cables (DACs) and Fiber Optic cables are integrated with or connected to transceiver device male cable connectors that include a latch that is configured to engage a retainer on a transceiver cage female cable connector on a computing device when the transceiver device male cable connector is inserted in the transceiver cage female cable connector to secure the DAC or Fiber Optic cable to the computing device.

However, such latch/retainer mechanisms for securing male cable connectors to female cable connectors require a user to release the engagement of the latch on the male cable connector with the retainer on the female cable connector (e.g., the user may use their finger(s) to press, lift, pull, or otherwise manipulate the latch in a manner that disengages the latch from the retainer), which can raise some issues. For example, the latch provided on the male cable connector can be difficult for a user to access (e.g., the latch on RJ45 male cable connectors is often short and difficult for a user to engage), and often requires a user to utilize a tool in order to release the latch from the retainer. Furthermore, in high density male cable connector/female cable connector environments (e.g., in situations where a plurality of RJ45 male cable connectors/RJ45 female cable connectors or transceiver device male cable connectors/transceiver cage female cable connectors are provided in a densely packed configuration on a switch device, storage system, or other computing device), the issues with accessing the latch on the male cable connector are exacerbated. Further still, some male cable connectors (e.g., the transceiver device male cable connectors discussed above) produce relatively high temperatures during their operation, and thus users must exercise caution when engaging the latch included thereon.

Accordingly, it would be desirable to provide male/female cable connector system that addresses the issues discussed above.

### SUMMARY

According to one embodiment, a female cable connector subsystem includes a female cable connector chassis that is configured to mount to a computing device; a female cable connector housing that is defined by the female cable connector chassis and that is configured to house a female cable connector; and a push/push securing mechanism that is included on the female cable connector chassis and that is configured to: engage a male cable connector subsystem when the male cable connector subsystem is moved a securing distance into the female cable connector chassis to secure the male cable connector subsystem in the female cable connector chassis in a secured orientation in which a male cable connector included on the male cable connector subsystem is connected to the female cable connector when the female cable connector is housed in the female cable connector chassis; and disengage the male cable connector subsystem in response to the male cable connector subsystem being moved from the secured orientation and a release distance into the female cable connector chassis to release the male cable connector subsystem from the female cable connector chassis.

### BRIEF DESCRIPTION OF THE DRAWINGS

FIG. 1 is a schematic view illustrating an embodiment of an Information Handling System (IHS).

FIG. 2A is a side view illustrating an embodiment of a male cable connector cabling system that may be included in the push/push male/female cable connector system of the present disclosure.

FIG. 2B is a top view illustrating an embodiment of the male cable connector cabling system of FIG. 2A.

FIG. 3A is a side view illustrating an embodiment of a male cable connector cabling system that may be included in the push/push male/female cable connector system of the present disclosure.

FIG. 3B is a top view illustrating an embodiment of the male cable connector cabling system of FIG. 3A.

FIG. 4A is a side view illustrating an embodiment of a female cable connector subsystem that may be included in the push/push male/female cable connector system of the present disclosure.

FIG. 4B is a top view illustrating an embodiment of the female cable connector subsystem of FIG. 4A.

FIG. 5A is a side view illustrating an embodiment of a female cable connector subsystem that may be included in the push/push male/female cable connector system of the present disclosure.

FIG. 5B is a side view illustrating an embodiment of a push-push securing mechanism included on the female cable connector subsystem of FIG. 5A.

FIG. 5C is a top view illustrating an embodiment of the female cable connector subsystem of FIG. 5A.

FIG. 5D is a top view illustrating an embodiment of the push-push securing mechanism of FIG. 5B.

FIG. 6 is a flow chart illustrating an embodiment of a method for connecting a male cable connector and a female cable connector.

FIG. 7A is a side view illustrating an embodiment of the male cable connector cabling system of FIGS. 3A and 3B being connected to the female cable connector subsystem of FIGS. 5A-5D.

FIG. 7B is a top view illustrating an embodiment of the male cable connector cabling system being connected to the female cable connector subsystem in FIG. 7A.

FIG. 8A is a side view illustrating an embodiment of a push/push securing element on the male cable connector cabling system of FIGS. 3A and 3B being connected to the push/push securing mechanism on the female cable connector subsystem of FIGS. 5A-5D.

FIG. 8B is a top view illustrating an embodiment of the push/push securing element being connected to the push/push securing mechanism in FIG. 8A.

FIG. 9A is a side view illustrating an embodiment of a push/push securing element on the male cable connector cabling system of FIGS. 3A and 3B being connected to the push/push securing mechanism on the female cable connector subsystem of FIGS. 5A-5D.

FIG. 9B is a top view illustrating an embodiment of the push/push securing element being connected to the push/push securing mechanism in FIG. 9A.

FIG. 10A is a side view illustrating an embodiment of a push/push securing element on the male cable connector cabling system of FIGS. 3A and 3B being connected to the push/push securing mechanism on the female cable connector subsystem of FIGS. 5A-5D.

FIG. 10B is a top view illustrating an embodiment of the push/push securing element on being connected to the push/push securing mechanism in FIG. 10A.

FIG. 11A is a side view illustrating an embodiment of a push/push securing element on the male cable connector cabling system of FIGS. 3A and 3B connected to the push/push securing mechanism on the female cable connector subsystem of FIGS. 5A-5D.

FIG. 11B is a top view illustrating an embodiment of the push/push securing element connected to the push/push securing mechanism in FIG. 11A.

FIG. 12A is a side view illustrating an embodiment of a push/push securing element on the male cable connector cabling system of FIGS. 3A and 3B connected to the push/push securing mechanism on the female cable connector subsystem of FIGS. 5A-5D.

FIG. 12B is a top view illustrating an embodiment of the push/push securing element connected to the push/push securing mechanism in FIG. 12A.

FIG. 13A is a side view illustrating an embodiment of the male cable connector cabling system of FIGS. 3A and 3B connected to the female cable connector subsystem of FIGS. 5A-5D.

FIG. 13B is a top view illustrating an embodiment of the male cable connector cabling system connected to the female cable connector subsystem in FIG. 13A.

FIG. 14A is a side view illustrating an embodiment of a push/push securing element on the male cable connector cabling system of FIGS. 3A and 3B being disconnected from the push/push securing mechanism on the female cable connector subsystem of FIGS. 5A-5D.

FIG. 14B is a top view illustrating an embodiment of the push/push securing element being disconnected from the push/push securing mechanism in FIG. 14A.

FIG. 15A is a side view illustrating an embodiment of a push/push securing element on the male cable connector cabling system of FIGS. 3A and 3B being disconnected from the push/push securing mechanism on the female cable connector subsystem of FIGS. 5A-5D.

FIG. 15B is a top view illustrating an embodiment of the push/push securing element being disconnected from the push/push securing mechanism in FIG. 15A.

FIG. 16A is a side view illustrating an embodiment of the male cable connector cabling system of FIGS. 3A and 3B disconnected from the female cable connector subsystem of FIGS. 5A-5D.

FIG. 16B is a top view illustrating an embodiment of the male cable connector cabling system disconnected to the female cable connector subsystem in FIG. 16A.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

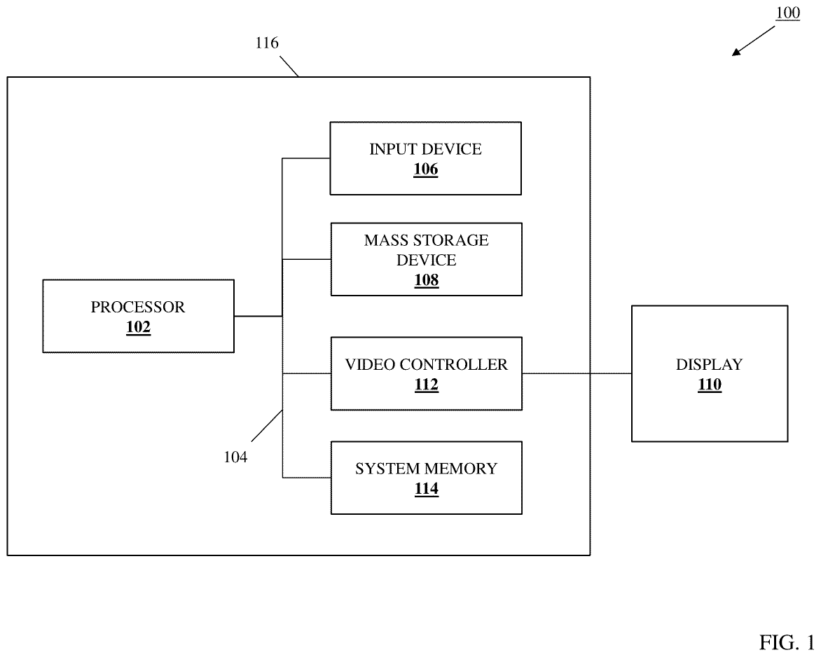

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

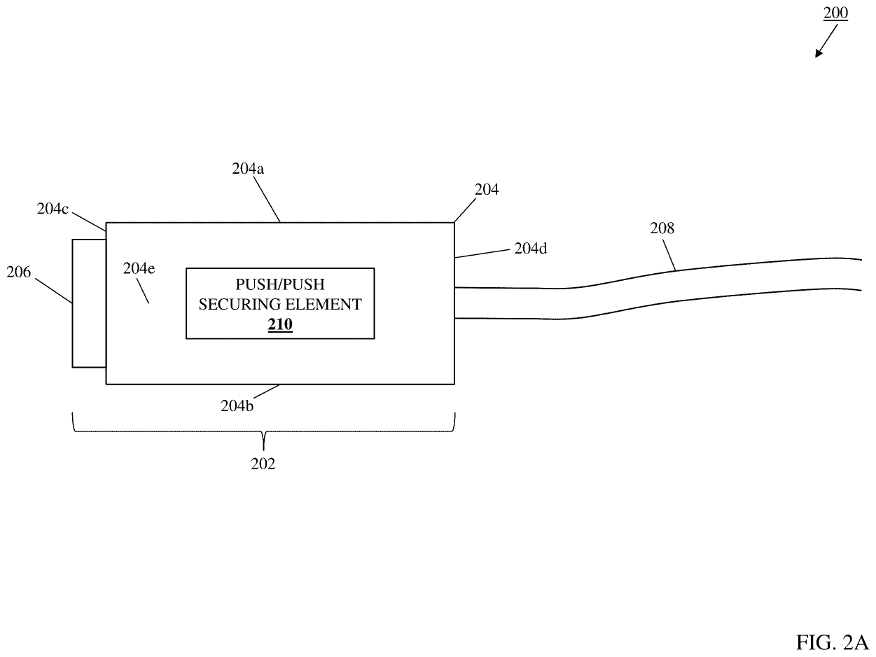

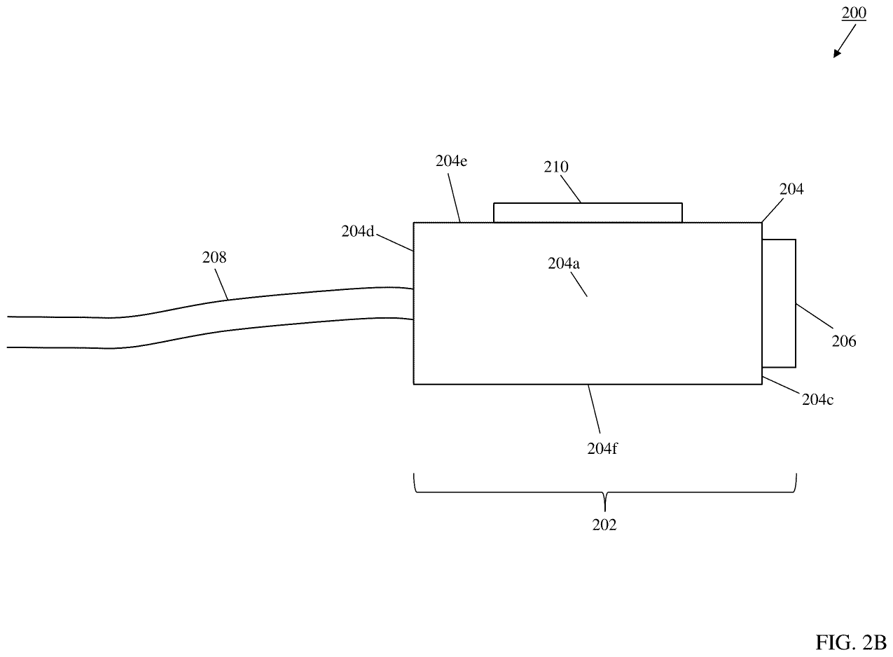

Referring now to FIGS. 2A and 2B, an embodiment of a male cable connector cabling system 200 is illustrated that may be included in the push/push male/female cable connector system of the present disclosure. In the illustrated embodiment, the male cable connector cabling system 200 includes a male cable connector subsystem 202 that, in the specific examples below, is described as being provided by an 8 Position, 8 Contact (8P8C) male cable connector subsystem that is wired according to the RJ-45 standard, but one of skill in the art in possession of the present disclosure will appreciate how the male cable connector subsystem 202 may be provided using a variety of male cable connector subsystem technologies while remaining within the scope of the present disclosure as well.

In the illustrated example, the male cable connector subsystem 202 includes a male cable connector base 204 having a top surface 204a, a bottom surface 204b that is located opposite the male cable connector base 204 from the top surface 204a, a front surface 204c that extends between the top surface 204a and the bottom surface 204b, a rear surface 204d that is located opposite the male cable connector base 204 from the front surface 204c and that extends between the top surface 204a and the bottom surface 204b, and a pair of side surfaces 204e and 204f that are located opposite the male cable connector base 204 from each other and that extend between the top surface 204a, the bottom surface 204b, the front surface 204c, and the rear surface 204d.

The male cable connector subsystem 202 also includes a male cable connector 206 that is located on the front surface 204c of the male cable connector base 204. In the specific examples below, the male cable connector 206 is described as being provided by an 8P8C male connector that is wired according to the RJ-45 standard and that is configured to connect to a female cable connector provided by an 8P8C female connector that is wired according to the RJ-45 standard, but one of skill in the art in possession of the present disclosure will appreciate how the male cable connector 206 may be provided using a variety of male cable connector technologies while remaining within the scope of the present disclosure as well. In some embodiments, the male cable connector subsystem 202 may include magnets located on or adjacent the front surface 204c of the male cable connector base 204 and about the perimeter of the male cable connector 206, which as described below may be configured to magnetically interact with magnets adjacent a female cable connector subsystem in order to align the male cable connector subsystem 202 with that female cable connector subsystem.

In the illustrated embodiment, the male cable connector cabling system 200 includes a cable 208 that is integrated with the male cable connector subsystem 202 and that extends from the rear surface 204d of the male cable connector base 204. In the specific examples below, the cable 208 is described as being provided by an Ethernet cable, but one of skill in the art in possession of the present disclosure will appreciate how the cable 208 may be provided using a variety of cable technologies while remaining within the scope of the present disclosure as well. As discussed below, in some embodiments the strength, stiffness, and/or other structure of the cable 208 may allow a user to move and connect the male cable connector subsystem 202 to a female cable connector subsystem using the cable 208 (e.g., a user may grasp the cable 208 without touching the male cable connector subsystem 202 and move the cable 208 to move and connect the male cable connector subsystem 202 to a female cable connector subsystem). However, in other embodiments, the strength, stiffness, and/or other structure of the cable 208 may not allow a user to move and connect the male cable connector subsystem 202 to a female cable connector subsystem using the cable 208 as described above, and a handle or other user engagement element (not illustrated) may extend from the cable connector base 204 (e.g., from the rear surface 204d) and may be grasped by a user to move and connect the male cable connector subsystem 202 to a female cable connector subsystem.

In the illustrated examples, the male cable connector subsystem 202 includes a push/push securing element 210 on the side surface 204e of the male cable connector base 204. A specific example of the push/push securing element 210 is illustrated and described below, but one of skill in the art in possession of the present disclosure will appreciate how the push/push securing element 210 may be located at a variety of different positions on the male cable connector subsystem 202, and/or may be provided by a variety of different features that are configured to engage a push/push securing mechanism on a female cable connector subsystem as described below, while remaining within the scope of the present disclosure as well. Furthermore, while a specific male cable connector cabling system 200 has been illustrated and described, one of skill in the art in possession of the present disclosure will recognize that the male cable connector cabling system of the present disclosure may include a variety of components and component configurations while remaining within the scope of the present disclosure as well.

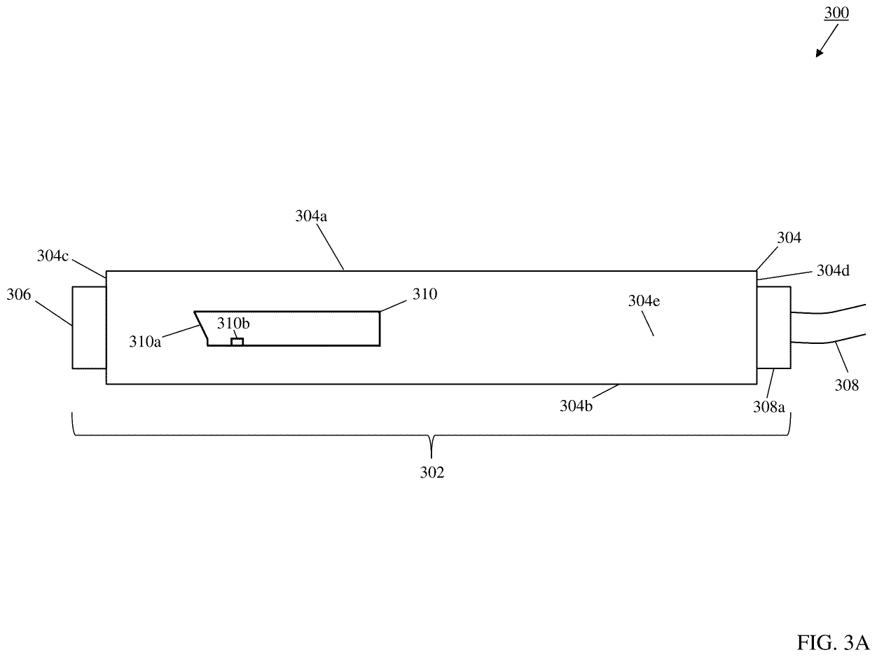

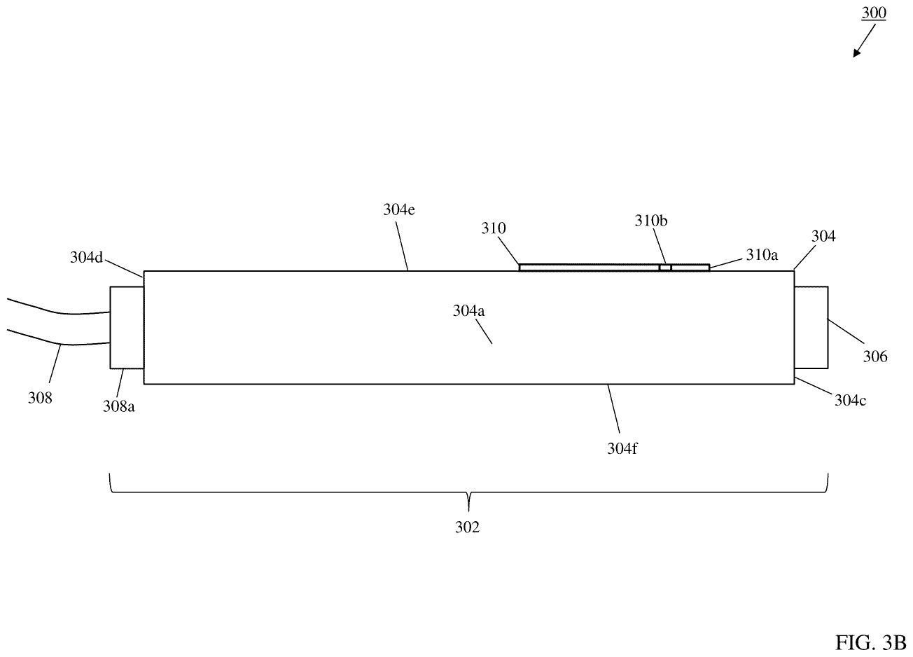

Referring now to FIGS. 3A and 3B, an embodiment of a male cable connector cabling system 300 is illustrated that may be included in the push/push male/female cable connector system of the present disclosure. In the illustrated embodiment, the male cable connector cabling system 300 includes a male cable connector subsystem 302 that, in the specific examples below, is described as being provided by a transceiver device such as an Small Form-factor Pluggable (SFP) transceiver device or a Direct Attach Cable (DAC) transceiver device, but one of skill in the art in possession of the present disclosure will appreciate how the male cable connector subsystem 302 may be provided using a variety of male cable connector subsystem technologies while remaining within the scope of the present disclosure as well.

In the illustrated example, the male cable connector subsystem 302 includes a male cable connector base 304 having a top surface 304a, a bottom surface 304b that is located opposite the male cable connector base 304 from the top surface 304a, a front surface 304c that extends between the top surface 304a and the bottom surface 304b, a rear surface 304d that is located opposite the male cable connector base 304 from the front surface 304c and that extends between the top surface 304a and the bottom surface 304b, and a pair of side surfaces 304e and 304f that are located opposite the male cable connector base 304 from each other and that extend between the top surface 304a, the bottom surface 304b, the front surface 304c, and the rear surface 304d.

The male cable connector subsystem 302 also includes a male cable connector 306 that is located on the front surface 304c of the male cable connector base 304. In the specific examples below, the male cable connector 306 is described as being provided by an SFP transceiver male connector that is configured to connect to a SFP transceiver female connector, or a DAC transceiver male connector that is configured to connect to a DAC transceiver female connector, but one of skill in the art in possession of the present disclosure will appreciate how the male cable connector 306 may be provided using a variety of male cable connector technologies while remaining within the scope of the present disclosure as well. In some embodiments, the male cable connector subsystem 302 may include magnets located on or adjacent the front surface 304c of the male cable connector base 304 and about the perimeter of the male cable connector 306, which as described below may be configured to magnetically interact with magnets adjacent a female cable connector subsystem in order to align the male cable connector subsystem 302 with that female cable connector subsystem 302.

In the illustrated embodiment, the male cable connector cabling system 300 includes a cable 308 that, in the specific examples provided below, may be connected to and disconnected from the male cable connector subsystem 302 via a transceiver cable connector 308a (e.g., in the case of the SFP transceiver devices discussed above). However, one of skill in the art in possession of the present disclosure will appreciate how the cable 308 may be integrated with the male cable connector subsystem 302 similarly as described above with reference to FIGS. 2A and 2B (e.g., in the case of the DAC transceiver devices discussed above) while remaining within the scope of the present disclosure as well. In the specific examples below, the cable 308 is described as being provided by fiber optic cables (e.g., for use with the SFP transceiver devices discussed above) or copper cables (e.g., for use with the DAC transceiver devices discussed above), but one of skill in the art in possession of the present disclosure will appreciate how the cable 308 may be provided using a variety of cable technologies while remaining within the scope of the present disclosure as well.

As discussed below, in some embodiments the strength, stiffness, and/or other structure of the cable 308 (e.g., a DAC transceiver copper cable) may allow a user to move and connect the male cable connector subsystem 302 to a female cable connector subsystem using the cable 308 (e.g., a user may grasp the cable 308 without touching the male cable connector subsystem 302 and move the cable 308 to move and connect the male cable connector subsystem 302 to a female cable connector subsystem). However, in other embodiments, the strength, stiffness, and/or other structure of the cable 308 (e.g., an SFP transceiver fiber optic cable) may not allow a user to move and connect the male cable connector subsystem 302 to a female cable connector subsystem using the cable 308 as described above, and a handle or other user engagement element (not illustrated) may extend from the cable connector base 304 (e.g., from the rear surface 304d) and may be grasped by a user to move and connect the male cable connector subsystem 302 to a female cable connector subsystem.

In the illustrated examples, the male cable connector subsystem 302 includes a push/push securing element 310 on the side surface 304e of the male cable connector base 304, and one of skill in the art in possession of the present disclosure will appreciate how the push/push securing element 310 may be mounted to the side surface 304e of the male cable connector base 304, integrated with the side surface of the male cable connector base 304, and/or provided on the male cable connector base 304 in others manners that will fall within the scope of the present disclosure. In the specific example of the push/push securing element 310 illustrated and described below, the push/push securing element 310 includes a push/push securing mechanism engagement surface 310a, and defines a push/push securing mechanism connection aperture 310b. However, as described above, while a specific push/push securing element 310 is illustrated and described herein, one of skill in the art in possession of the present disclosure will appreciate how the push/push securing element 210 may be located at a variety of different positions on the male cable connector subsystem 302, and/or may be provided by a variety of different features that are configured to engage a push/push securing mechanism on a female cable connector subsystem as described below, while remaining within the scope of the present disclosure as well. As such, one of skill in the art in possession of the present disclosure will appreciate that the male cable connector cabling system of the present disclosure may include a variety of components and component configurations while remaining within the scope of the present disclosure as well.

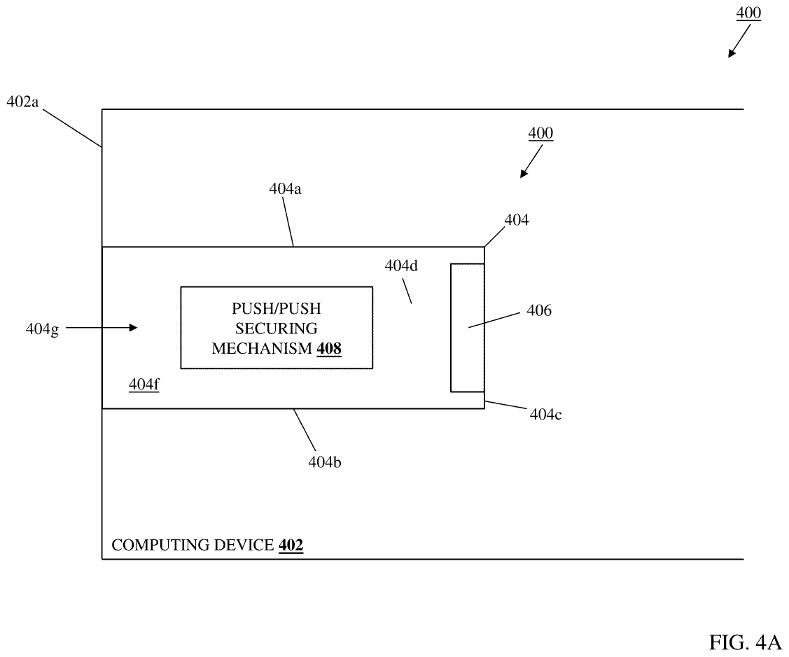

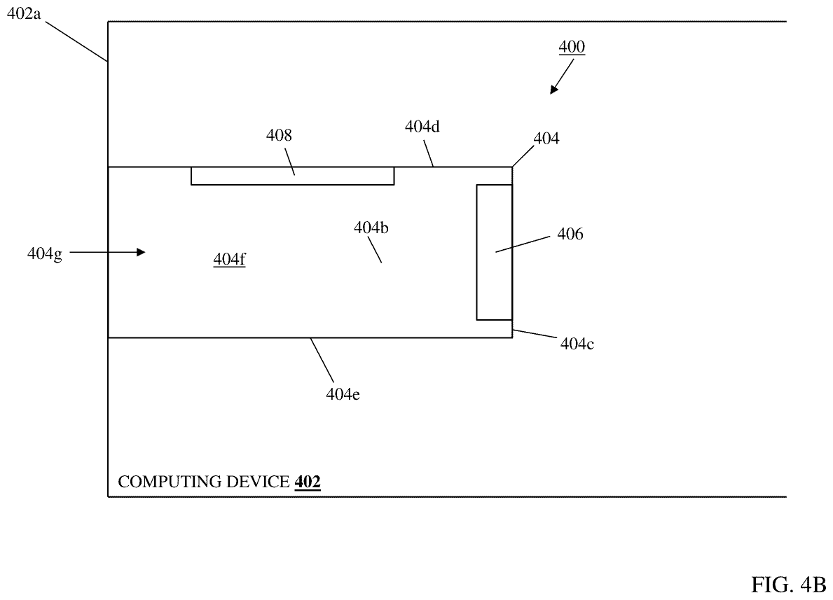

Referring now to FIGS. 4A and 4B, an embodiment of a female cable connector subsystem 400 is illustrated that may be included in the push/push male/female cable connector system of the present disclosure. In the illustrated embodiment, the female cable connector subsystem 400 is provided in a computing device 402 having an outer surface 402a, but one of skill in the art in possession of the present disclosure will appreciate how the female cable connector subsystem 400 may be provided in a computing device in a variety of manners that will fall within the scope of the present disclosure. In the specific examples below, the female cable connector subsystem 400 is described as being provided by an 8P8C female cable connector subsystem that is wired according to the RJ-45 standard, but one of skill in the art in possession of the present disclosure will appreciate how the female cable connector subsystem 400 may be provided using a variety of female cable connector subsystem technologies while remaining within the scope of the present disclosure as well.

In the illustrated example, the female cable connector subsystem 400 includes a female cable connector chassis 404 having a top wall 404a, a bottom wall 404b that is located opposite the female cable connector chassis 404 from the top wall 404a, a rear wall 404c that extends between the top wall 404a and the bottom wall 404b, and a pair of side walls 404d and 404e that are located opposite the female cable connector subsystem 400 from each other and that extend between the top wall 404a, the bottom wall 404b, and the rear wall 404c. The top wall 404a, the bottom wall 404b, the rear wall 404c, and the side walls 404d and 404e define a male cable connector subsystem housing 404f between them, and a male cable connector subsystem housing entrance 404g that is located immediately adjacent the outer surface 402a of the computing device 402 and that provides access to the male cable connector subsystem housing 404f. In some embodiments, the computing device 402 and/or female cable connector subsystem 400 may include magnets located on or adjacent the outer surface 402a of the computing device 402 and about the perimeter of the male cable connector subsystem housing entrance 404g, which as described below may be configured to magnetically interact with magnets on a male cable connector subsystem in order to align that male cable connector subsystem with the female cable connector subsystem 400.

The female cable connector subsystem 400 also includes a female cable connector 406 that is located adjacent the rear wall 404c of the female cable connector chassis 404. In the specific examples below, the female cable connector 406 is described as being provided by an 8P8C female connector that is wired according to the RJ-45 standard and that is configured to connect to a male cable connector provided by an 8P8C male connector that is wired according to the RJ-45 standard, but one of skill in the art in possession of the present disclosure will appreciate how the female cable connector 406 may be provided using a variety of female cable connector technologies while remaining within the scope of the present disclosure as well.

In the illustrated examples, the female cable connector subsystem 400 includes a push/push securing mechanism 408 on the side wall 404d of the female cable connector chassis 404. A specific example of the push/push securing mechanism 408 is illustrated and described below, but one of skill in the art in possession of the present disclosure will appreciate how the push/push securing mechanism 408 may be located at a variety of different positions on the female cable connector subsystem 400, and/or may be provided by a variety of different features that are configured to engage a push/push securing element on a male cable connector subsystem as described below, while remaining within the scope of the present disclosure as well. Furthermore, while a specific female cable connector subsystem 400 has been illustrated and described, one of skill in the art in possession of the present disclosure will recognize that the female cable connector subsystem of the present disclosure may include a variety of components and component configurations while remaining within the scope of the present disclosure as well.

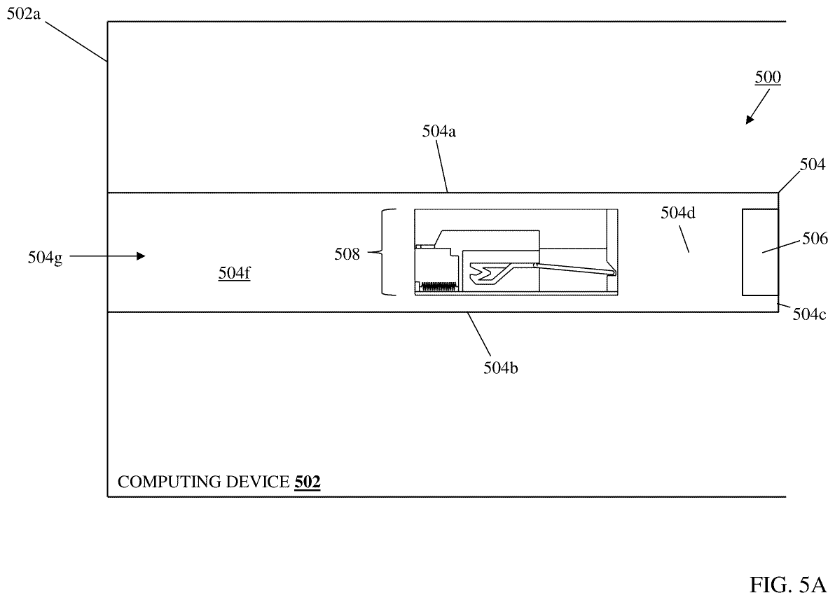

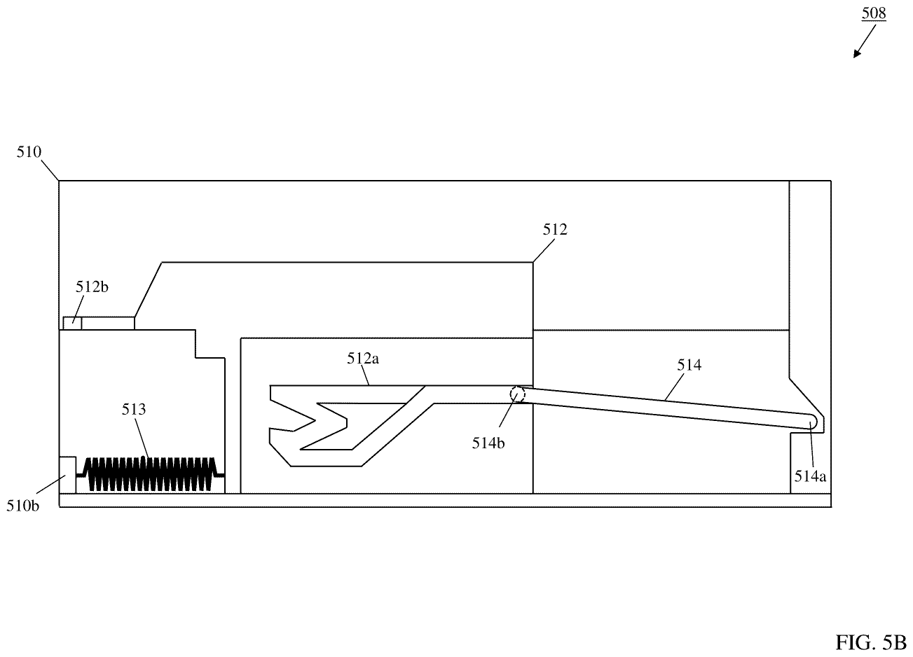

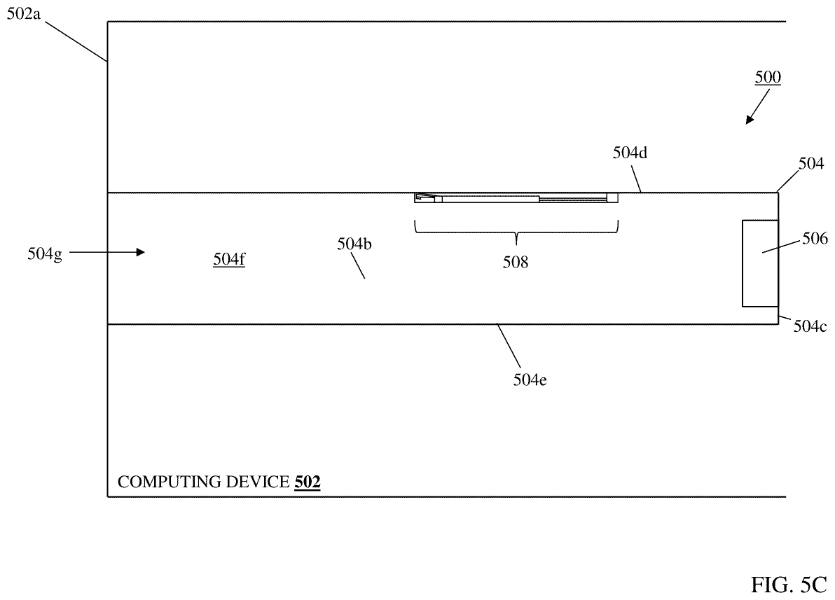

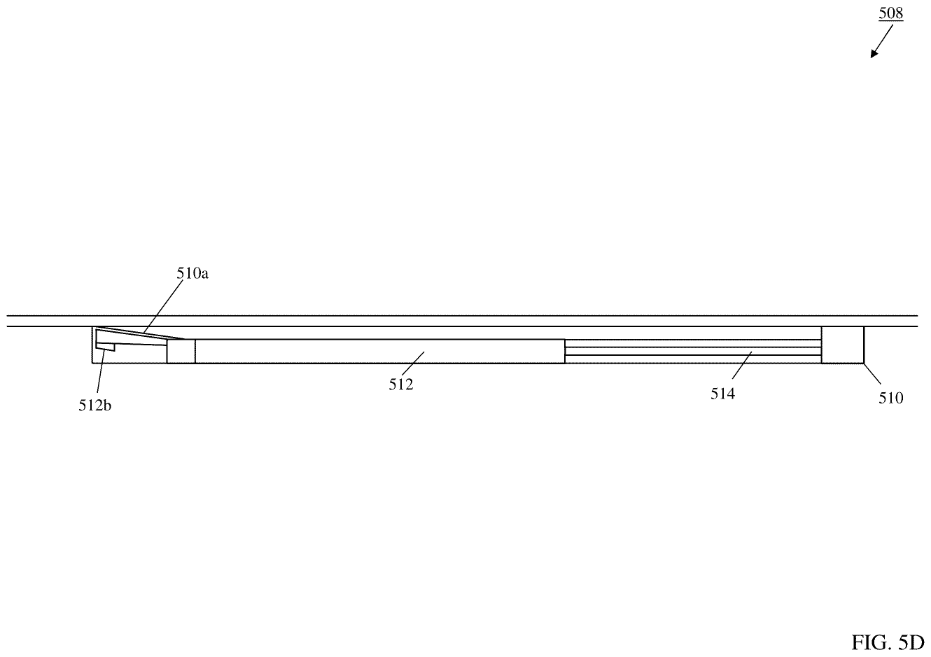

Referring now to FIGS. 5A and 5B, an embodiment of a female cable connector subsystem 500 is illustrated that may be included in the push/push male/female cable connector system of the present disclosure. In the illustrated embodiment, the female cable connector subsystem 500 is provided in a computing device 502 having an outer surface 502a, but one of skill in the art in possession of the present disclosure will appreciate how the female cable connector subsystem 500 may be provided in a computing device in a variety of manners that will fall within the scope of the present disclosure. In the specific examples below, the female cable connector subsystem 500 is described as being provided by a transceiver cage such as an SFP transceiver cage or a DAC transceiver cage, but one of skill in the art in possession of the present disclosure will appreciate how the female cable connector subsystem 500 may be provided using a variety of female cable connector subsystem technologies while remaining within the scope of the present disclosure as well.

In the illustrated example, the female cable connector subsystem 500 includes a female cable connector chassis 504 having a top wall 504a, a bottom wall 504b that is located opposite the female cable connector chassis 504 from the top wall 504a, a rear wall 504c that extends between the top wall 504a and the bottom wall 504b, and a pair of side walls 504d and 504e that are located opposite the female cable connector subsystem 500 from each other and that extend between the top wall 504a, the bottom wall 504b, and the rear wall 504c. The top wall 504a, the bottom wall 504b, the rear wall 504c, and the side walls 504d and 504e define a male cable connector subsystem housing 504f between them, and a male cable connector subsystem housing entrance 504g that is located immediately adjacent the outer surface 502a of the computing device 502 and that provides access to the main cable connector subsystem housing 504f. In some embodiments, the computing device 502 and/or female cable connector subsystem 500 may include magnets located on or adjacent the outer surface 502a of the computing device 502 and about the perimeter of the male cable connector subsystem housing entrance 504g, which as described below may be configured to magnetically interact with magnets on a male cable connector subsystem in order to align that male cable connector subsystem with the female cable connector subsystem 500.

The female cable connector subsystem 500 also includes a female cable connector 506 that is located adjacent the rear wall 504c of the female cable connector chassis 504. For example, the male cable connector subsystem housing 504f defined by the female cable connector chassis 504 may include a female cable connector housing that is located adjacent the rear wall 504c of the female cable connector chassis 504, which allows a circuit board (not illustrated) that includes the female cable connector 506 to be located adjacent the female cable connector chassis 504 to position the female cable connector 506 in the female cable connector housing as illustrated in FIGS. 5A and 5C. In the specific examples below, the female cable connector 506 is described as being provided by an SFP female transceiver connector or a DAC female transceiver connector, but one of skill in the art in possession of the present disclosure will appreciate how the female cable connector 506 may be provided using a variety of female cable connector technologies while remaining within the scope of the present disclosure as well.

In the illustrated examples, the female cable connector subsystem 500 includes a push/push securing mechanism 508 on the side wall 504d of the female cable connector chassis 504. With reference to FIGS. 5B and 5D, the push/push securing mechanism 508 includes a base 510 that may be mounted to the side wall 504d of the female cable connector chassis 500, integrated into the side wall 504d of the female cable connector chassis 500, and/or provided in a variety of manners that would be apparent to one of skill in the art in possession of the present disclosure. The base 510 includes an activation surface 510a and a biasing element mounting feature 510b. A slider element 512 is moveably coupled to the base 510, defines a secure/release channel 512a, and includes a push/push securing element connection member 512b.

A biasing element 513 is mounted to the slider element 512 and to the biasing element mounting feature 510b on the base 510, and as described below resiliently biases the slider element 512 against movement relative to the base 510. A rod element 514a includes a first end 514a that is rotatably coupled to the base 510, and a second end 514b that extends into the secure/release channel 512a defined by the slider element 512, and as described below the second end 514b of the rod element 514a is configured to move “clockwise” (from the point of view of FIG. 5B) through a loop provided by the secure/release channel 512a (while rotating about its first end 514a relative to the base 510) in response to movement of the slider element 512 relative to the base 510.

However, while a specific example of the push/push securing mechanism 508 is illustrated and described below, one of skill in the art in possession of the present disclosure will appreciate how the push/push securing mechanism 508 may be located at a variety of different positions on the female cable connector subsystem 500, and/or may be provided by a variety of different features that are configured to engage a push/push securing element on a male cable connector subsystem as described below, while remaining within the scope of the present disclosure as well. Furthermore, while a specific female cable connector subsystem 500 has been illustrated and described, one of skill in the art in possession of the present disclosure will recognize that the female cable connector subsystem of the present disclosure may include a variety of components and component configurations while remaining within the scope of the present disclosure as well.

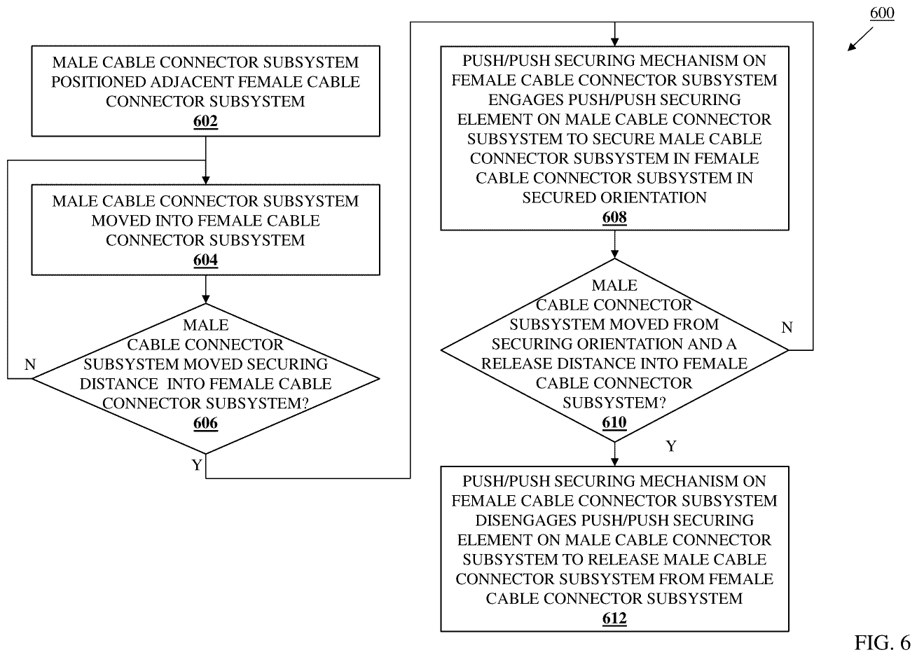

Referring now to FIG. 6, an embodiment of a method 600 for connecting a male cable connector and a female cable connector is illustrated. As discussed below, the systems and methods of the present disclosure provide a male cable connector subsystem that may be pushed into a female cable connector subsystem to secure it to the female cable connector subsystem in a secured orientation, and then pushed into the female cable connector from the secured orientation to release it from the female cable connector subsystem. For example, the push/push male/female cable connector system of the present disclosure may include a male cable connector subsystem having a male cable connector, and a computing device having a female cable connector subsystem that includes a female cable connector and a push/push securing mechanism. The push/push securing mechanism on the female cable connector subsystem engages the male cable connector subsystem when it is moved a securing distance into the female cable connector subsystem, which secures the male cable connector subsystem in the female cable connector subsystem in a secured orientation in which the male cable connector is connected to the female cable connector. The push/push securing mechanism on the female cable connector subsystem disengages the male cable connector subsystem when it is moved from the secured orientation and a release distance into the female cable connector subsystem, which releases the male cable connector subsystem from the female cable connector subsystem. As such, the issues associated with the connection and disconnection of male cable connectors and female cable connectors discussed above are remedied.

The method 600 is described below using the male cable connector subsystem 300 discussed above with reference to FIGS. 3A and 3B, and the female cable connector subsystem 500 discussed above with reference to FIGS. 5A-5D, and thus describes the push/push male/female cable connector system of the present disclosure used with a transceiver device “male cable connector subsystem” and transceiver cage “female cable connector subsystem” that implement the specific push/push securing element and push/push securing mechanism, respectively, illustrated and discussed above with reference to FIGS. 3A, 3B, 5B, and 5D. However, one of skill in the art in possession of the present disclosure will appreciate how the method 600 may be performed using the male cable connector subsystem 200 discussed above with reference to FIGS. 2A and 2B, and the female cable connector subsystem 400 discussed above with reference to FIGS. 4A and 4B (e.g., an RJ-45 male cable connector subsystem and RJ-45 female cable connector subsystem), as well as using other male cable connector subsystems and female cable connector subsystems that one of skill in the art would recognize as falling within the scope of the present disclosure.

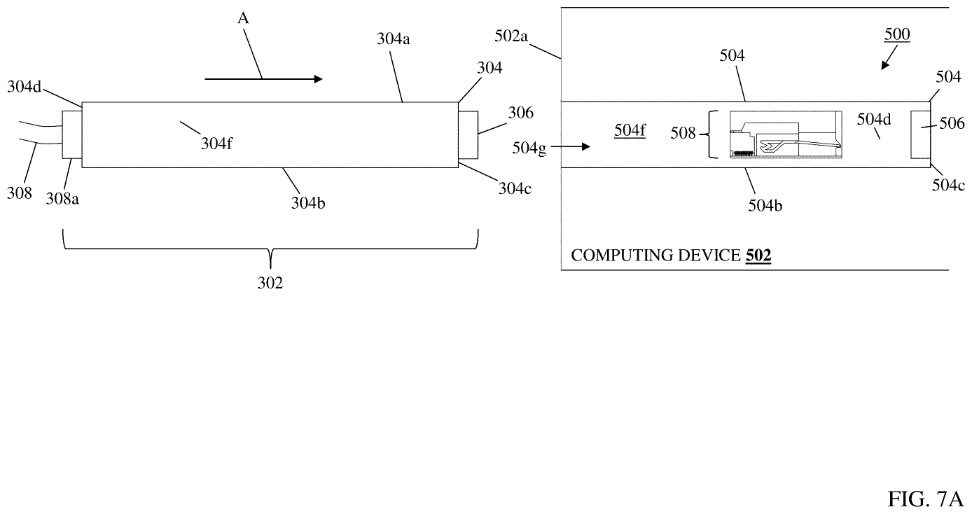

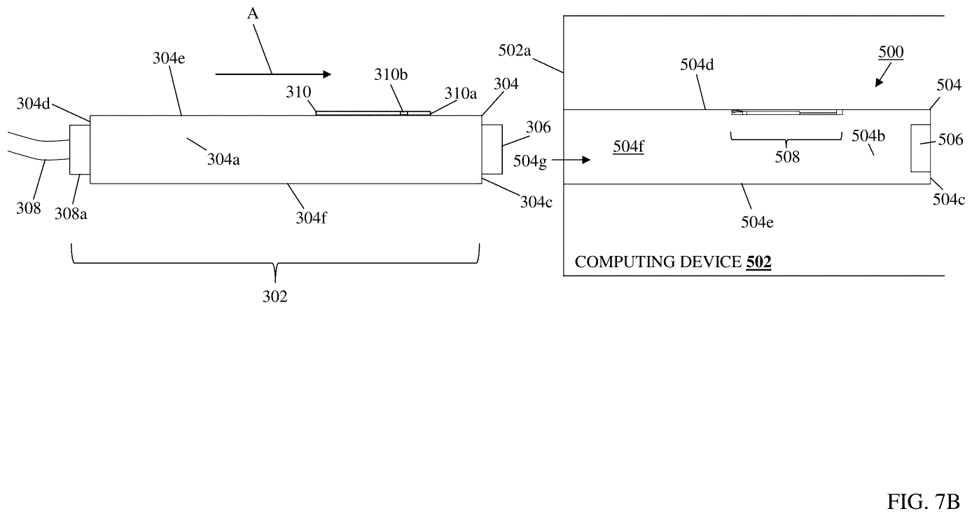

The method 600 begins at block 602 where a male cable connector subsystem is positioned adjacent a female cable connector subsystem. With reference to FIGS. 7A and 7B, in an embodiment of block 602, the male cable connector cabling system 300 is positioned adjacent the female cable connector subsystem 500 in the computing device 502 such that the male cable connector 306 on the male cable connector subsystem 302 located immediately adjacent the male cable connector subsystem housing entrance 504g, and the push/push securing element 310 on the male cable connector subsystem 302 is aligned with the push/push securing mechanism 508 on the female cable connector subsystem 500.

As discussed above, in some embodiments the strength, stiffness, and/or other structure of the cable 308 (e.g., a DAC transceiver copper cable) may allow a user to position the male cable connector subsystem 302 adjacent the female cable connector subsystem 500 using the cable 308 (e.g., a user may grasp the cable 308 without touching the male cable connector subsystem 302 and move the cable 308 to position the male cable connector subsystem 302 adjacent the female cable connector subsystem 500 as illustrated in FIGS. 7A and 7B) at block 602. However, in other embodiments, the strength, stiffness, and/or other structure of the cable 308 (e.g., an SFP transceiver fiber optic cable) may not allow a user to position the male cable connector subsystem 302 adjacent the female cable connector subsystem 500 using the cable 308 as described above, and a handle or other user engagement element (not illustrated) may extend from the cable connector base 304 (e.g., from the rear surface 304d) and may be grasped by a user to position the male cable connector subsystem 302 adjacent the female cable connector subsystem 500 as illustrated in FIGS. 7A and 7B.

As also described above, in some embodiments the male cable connector subsystem 302 may include magnets located on or adjacent the front surface 304c of the male cable connector base 304 and about the perimeter of the male cable connector 306, and the computing device 502 and/or female cable connector subsystem 500 may include magnets located on or adjacent the outer surface 502a of the computing device 502 and about the perimeter of the male cable connector subsystem housing entrance 504g, and those magnets may magnetically interact at block 602 in order to align the male cable connector subsystem 302 with the female cable connector subsystem 500 when the male cable connector subsystem 302 is positioned adjacent the female cable connector subsystem 500 as illustrated in FIGS. 7A and 7B at block 602.

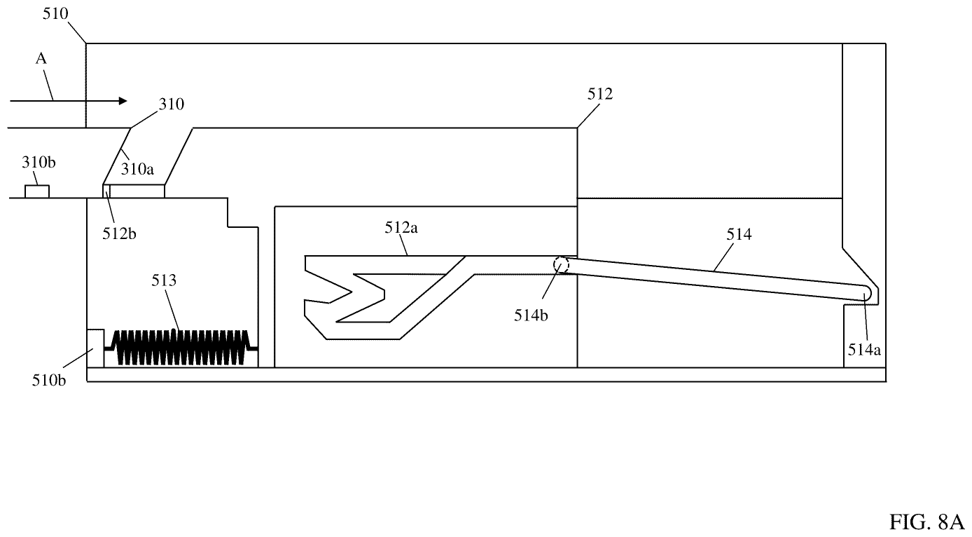

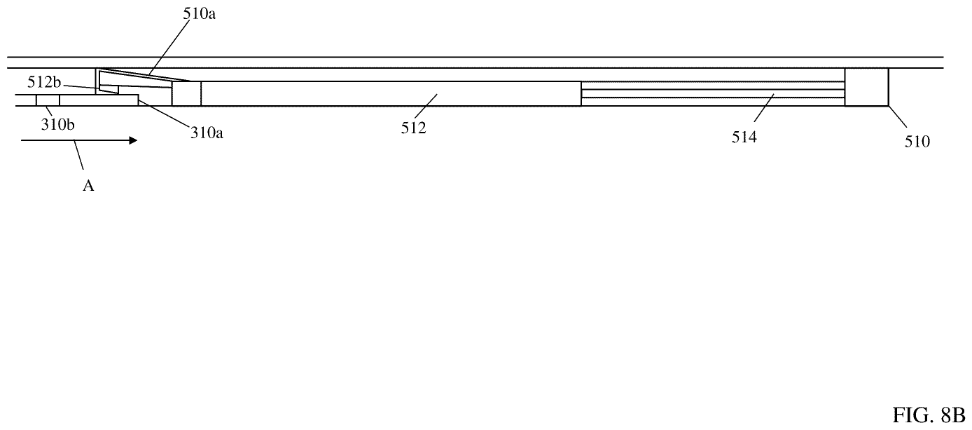

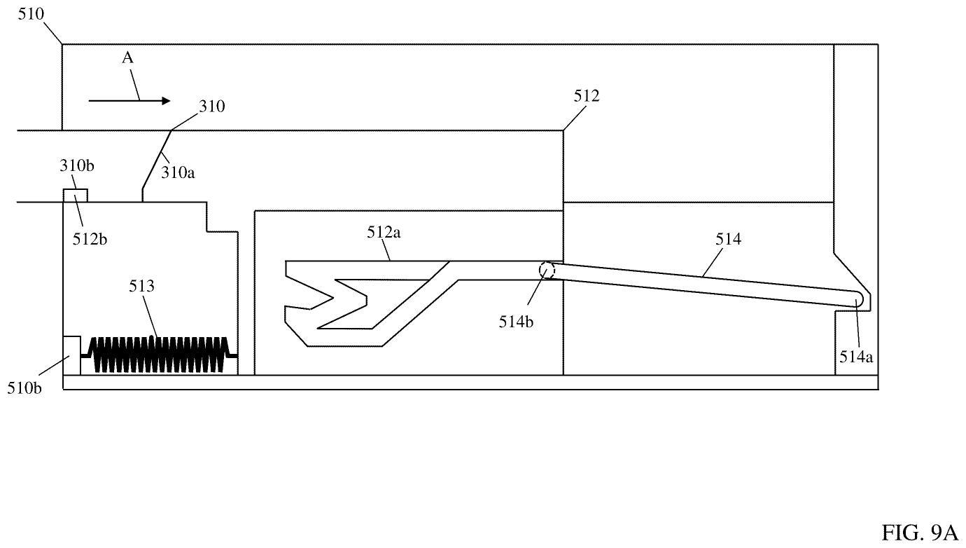

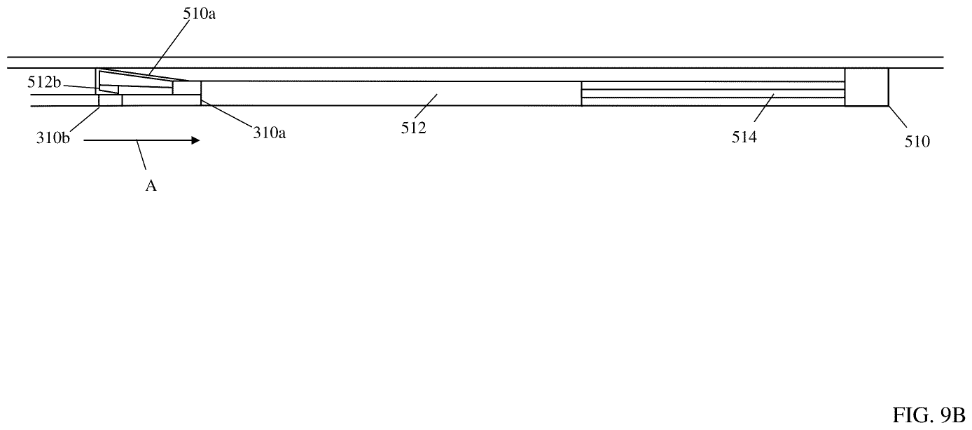

The method 600 then proceeds to block 604 where the male cable connector subsystem is moved into the female cable connector subsystem. With continued reference to FIGS. 7A and 7B, in an embodiment of block 604, the male cable connector subsystem 302 may be moved in a direction A such that the male cable connector 306 on the male cable connector subsystem 302 enters the male cable connector subsystem housing 504f defined by the female cable connector subsystem 500 via the male cable connector subsystem housing entrance 504g. Furthermore, continued movement of the male cable connector subsystem 302 in the direction A will cause the push/push securing element 310 on the male cable connector subsystem 302 to move towards the push/push securing mechanism 508 on the female cable connector subsystem 500, as illustrated in FIGS. 8A and 8B, until the push/push securing mechanism engagement surface 310a on the push/push securing element 310 engages the slider element 512 and the push/push securing element connection member 512b on the slider element 512 is located immediately adjacent the push/push securing mechanism connection aperture 310b defined by the push/push securing element 310, as illustrated in FIGS. 9A and 9B.

As discussed above, in some embodiments the strength, stiffness, and/or other structure of the cable 308 (e.g., a DAC transceiver copper cable) may allow a user to move the male cable connector subsystem 302 in the direction A and into the female cable connector subsystem 500 using the cable 308 (e.g., a user may grasp the cable 308 without touching the male cable connector subsystem 302 and move the cable 308 to move the male cable connector subsystem 302 in the direction A and into the female cable connector subsystem 500) at block 602. However, in other embodiments, the strength, stiffness, and/or other structure of the cable 308 (e.g., an SFP transceiver fiber optic cable) may not allow a user to move the male cable connector subsystem 302 in the direction A and into the female cable connector subsystem 500 using the cable 308 as described above, and a handle or other user engagement element (not illustrated) may extend from the cable connector base 304 (e.g., from the rear surface 304d) and may be grasped by a user to move the male cable connector subsystem 302 in the direction A and into the female cable connector subsystem 500.

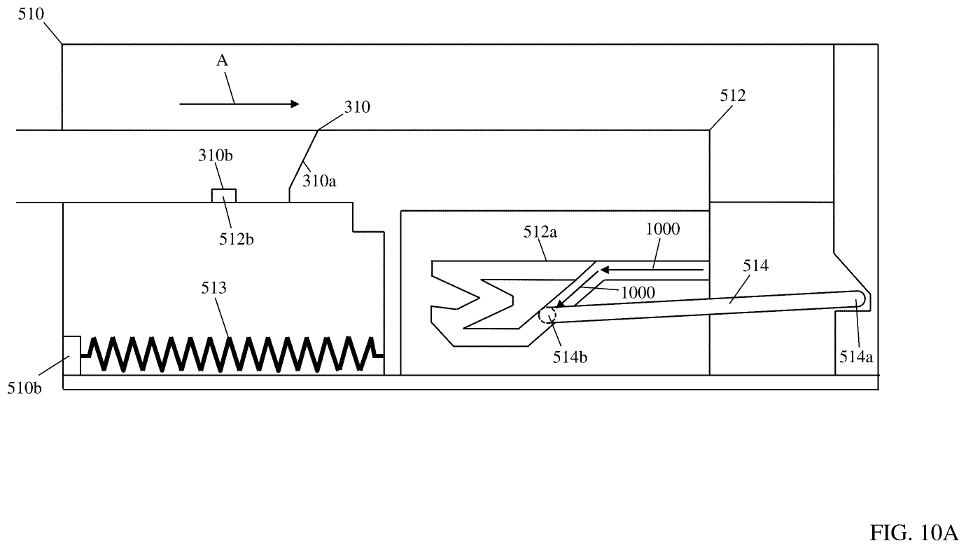

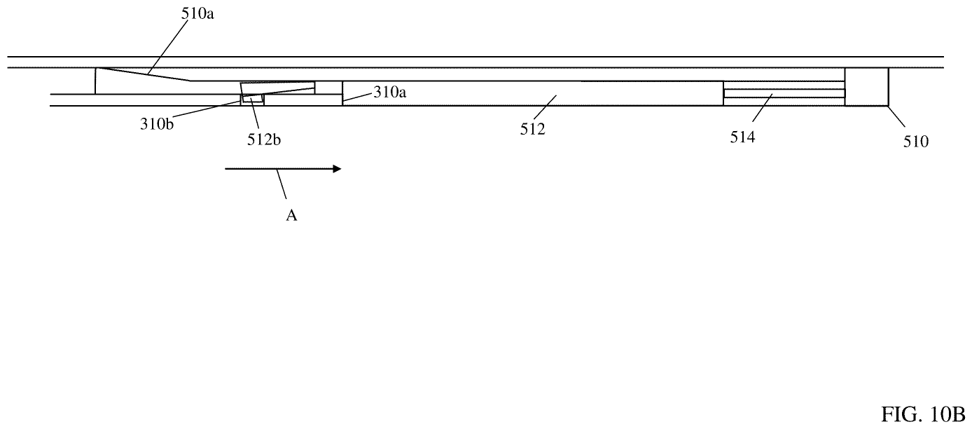

The method 600 then proceeds to decision block 606 where the method 600 proceeds depending on whether the male cable connector subsystem has moved a securing distance into the female cable connector subsystem. With reference to FIGS. 10A and 10B, after the push/push securing mechanism engagement surface 310a on the push/push securing element 310 engages the slider element 512 on the push/push securing mechanism 508, continued movement of the male cable connector subsystem 302 in the direction A will move the slider element 512 in the direction A when the force provided by the user on the male cable connector subsystem 302 and transferred to the slider element 512 via the push/push securing element 310 overcomes the force provided by the biasing element 513 on the slider element 512 (i.e., a spring that provides the biasing element 513 will expand and provide a force that is opposite the force of the push/push securing element 310 on the slider element 512 that moves the slider element 512 in the direction A).

As can be seen in FIGS. 9B and 10B, the movement of the slider element 512 in the direction A will cause the push/push securing element connection member 512b on the slider element 512 to engage the activation surface 510a on the base 510 of the push/push securing mechanism 508 and move the push/push securing element connection member 512b into the push/push securing mechanism connection aperture 310b defined by the push/push securing element 310. As will be appreciated by one of skill in the art in possession of the present disclosure, the positioning of the push/push securing element connection member 512b on the slider element 512 in the push/push securing mechanism connection aperture 310b defined by the push/push securing element 310 will prevent relative movement of the push/push securing element 310 and the slider element 512, which as discussed below will prevent the male cable connector subsystem 302 from being removed from the female cable connector subsystem 500 as long as the push/push securing element connection member 512b is positioned in the push/push securing mechanism connection aperture 310b.

Furthermore, FIGS. 10A and 10B also illustrate how, after the push/push securing mechanism engagement surface 310a on the push/push securing element 310 engages the slider element 512 on the push/push securing mechanism 508, continued movement of the male cable connector subsystem 302 in the direction A that moves the slider element 512 in the direction A will cause the second end 514b of the rod element 514 to move through a first portion of the secure/release channel 512a defined by the slider element 512 (as illustrated by arrows 1000 in FIG. 10A) while the rod element 514 rotates about its first end 514a. As discussed below and as will be appreciated by one of skill in the art in possession of the present disclosure, in the examples of the push/push securing element 310 and the push/push securing mechanism 508 provided herein, the secure/release channel 512a on the slider element 512 defines a securing distance that the male cable connector subsystem 300 must move into the female cable connector subsystem 500 in order to move the slider element 512 into a position in which rod element 514 engages the secure/release channel 512a in a manner that secures the male cable connector subsystem 300 in the female cable connector subsystem 500. As such, in an embodiment of decision block 606, the method 600 may proceed depending on whether the male cable connector subsystem 300 has moved the securing distance into the female cable connector subsystem 500.

If, at decision block 606, the male cable connector subsystem has not moved the securing distance into the female cable connector subsystem, the method 600 returns to block 604. As such, the method 600 may loop such that the male cable connector subsystem 302 continues to move into the female cable connector subsystem 500 until it has moved the securing distance into the female cable connector subsystem 500. Furthermore, while not illustrated or described herein in detail, one of skill in the art in possession of the present disclosure will appreciate that, if the user stops applying the force that is moving the male cable connector subsystem 302 into the female cable connector subsystem 500 before the male cable connector subsystem 302 has been moved the securing distance into the female cable connector subsystem 500, the force provided by the biasing element 513 on the slider element 512 will cause the slider element 512 to move the push/push securing element 310 and the male cable connector subsystem 302 out of the female cable connector subsystem 500, and will allow the male cable connector subsystem 302 to be removed from the female cable connector subsystem 500.

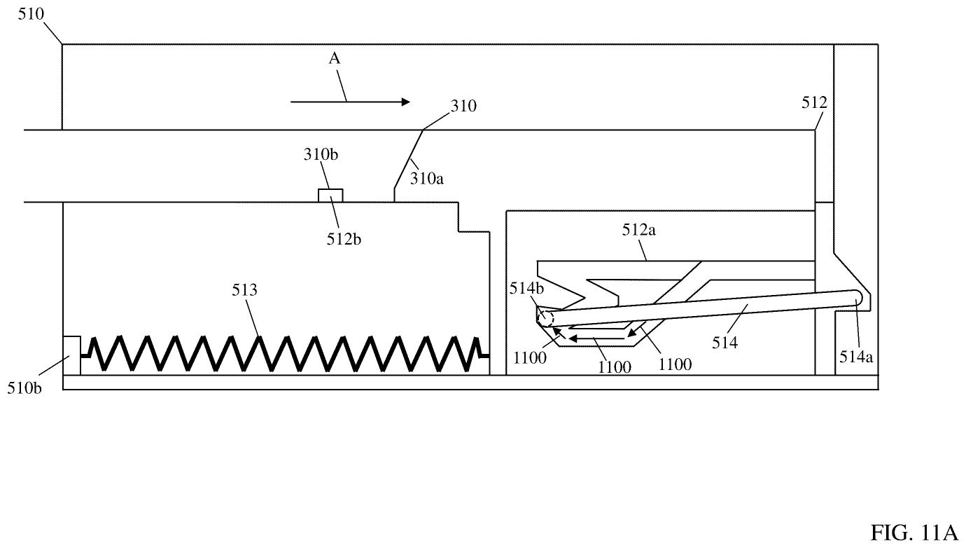

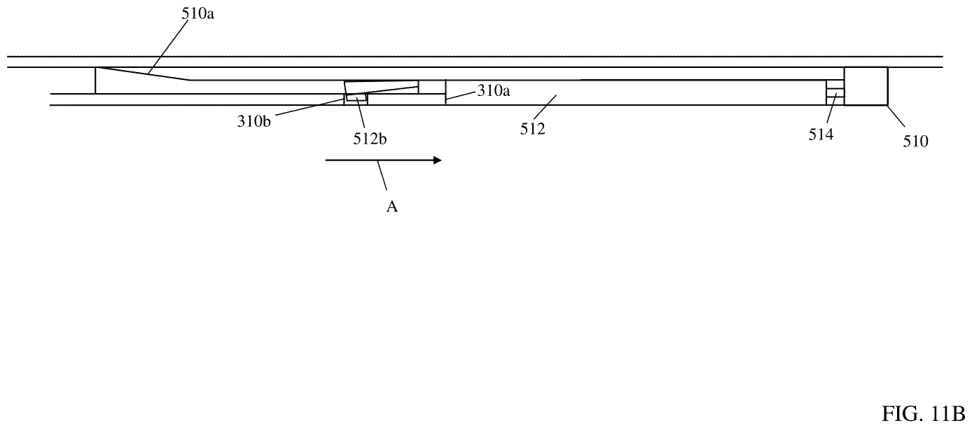

If, at decision block 606, the male cable connector subsystem has moved the securing distance into the female cable connector subsystem, the method 600 proceeds to block 608 where a push/push securing mechanism on the female cable connector subsystem engages a push/push securing element on the male cable connector subsystem to secure the male cable connector subsystem in the female cable connector subsystem in a secured orientation. With reference to FIGS. 11A and 11B, continued movement of the male cable connector subsystem 302 in the direction A and into the female cable connector subsystem 500 may move the male cable connector subsystem 302 the securing distance into the female cable connector subsystem 500 and, due to the engagement of the push/push securing mechanism engagement surface 310a on the push/push securing element 310 with the slider element 512 on the push/push securing mechanism 508, will move the slider element 512 in the direction A to cause the second end 514b of the rod element 514 to move through a second portion of the secure/release channel 512a defined by the slider element 512 (as illustrated by arrows 1100 in FIG. 11A) while the rod element 514 rotates about its first end 514a.

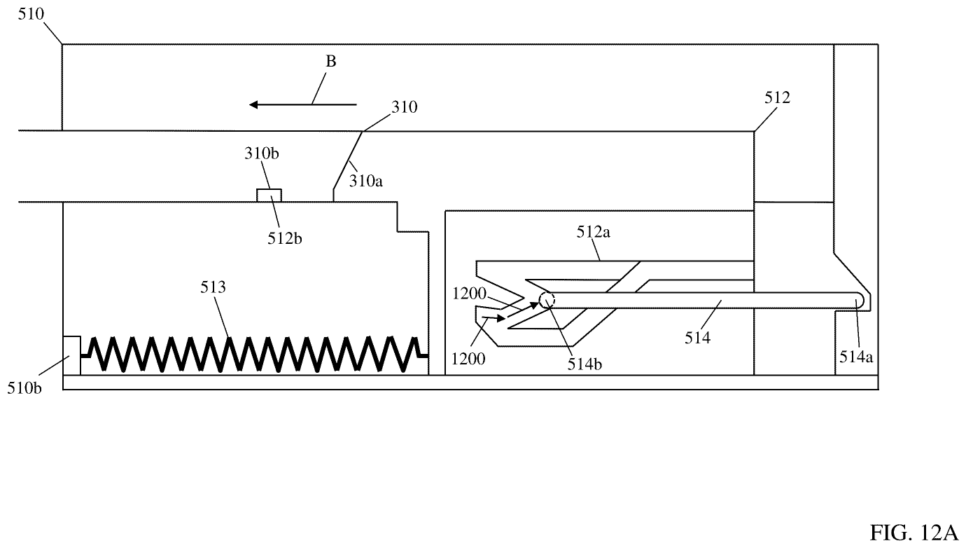

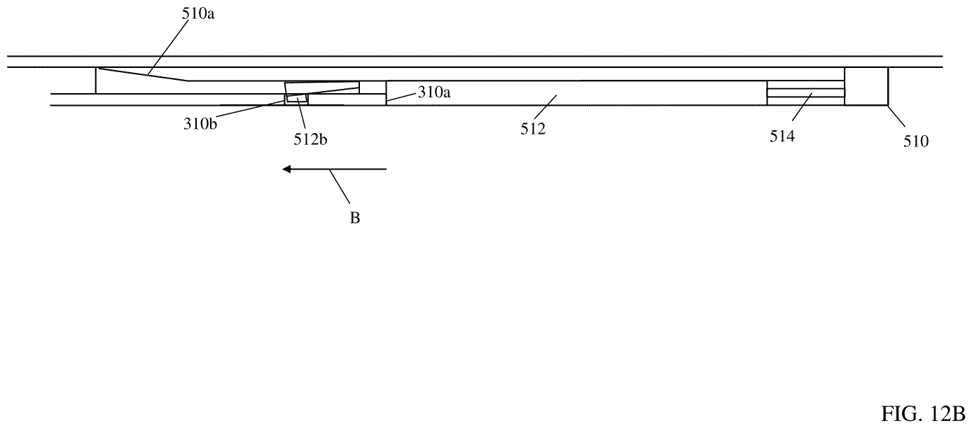

The movement of the second end 514b of the rod element 514 through the second portion of the secure/release channel 512a illustrated in FIG. 11A positions the second end 514b of the rod element 514 in a securing distance orientation in the secure/release channel 512a that corresponds to the securing distance that the male cable connector subsystem 302 has been moved into the female cable connector subsystem 500. As illustrated in FIGS. 12A and 12B, following the positioning of the second end 514b of the rod element 514 in the securing distance orientation in the secure/release channel 512a and when the user subsequently no longer applies the force on the male cable connector subsystem 302 that overcame the force provided by the biasing element 513, the force provided by the biasing element 513 will move the slider element 512 in a direction B that will cause the second end 514b of the rod element 514 to move through a third portion of the secure/release channel 512a defined by the slider element 512 (as illustrated by arrows 1200 in FIG. 12A) and into a securing orientation in the secure/release channel 512a while the rod element 514 rotates about its first end 514a. In some embodiments, the push/push securing mechanism 508 on the female cable connector subsystem 500 may be configured to generate a securing sound (e.g., a “click”) when the male cable connector subsystem 302 is moved into the female cable connector subsystem 500 the securing distance and/or when the second end 514b of the rod element 514 is provided in the secured orientation in the secure/release channel 512a.

Thus, with the second end 514b of the rod element 514 positioned in the securing orientation in the secure/release channel 512 as illustrated in FIG. 12A and no force provided on the male cable connector subsystem 302 by the user, the force provided by the biasing element 513 on the slider element 512 will hold the second end 514b of the rod element 514 in the securing orientation in the secure/release channel 512, and the positioning of the push/push securing element connection member 512b on the slider element 512 in the push/push securing mechanism connection aperture 310b defined by the push/push securing element 310 will prevent relative movement of the push/push securing element 310 and the slider element 512, thus providing the male cable connector subsystem 302 in a secured orientation in the female cable connector subsystem 500 that prevents the male cable connector subsystem 302 from being moved out of the female cable connector subsystem 500.

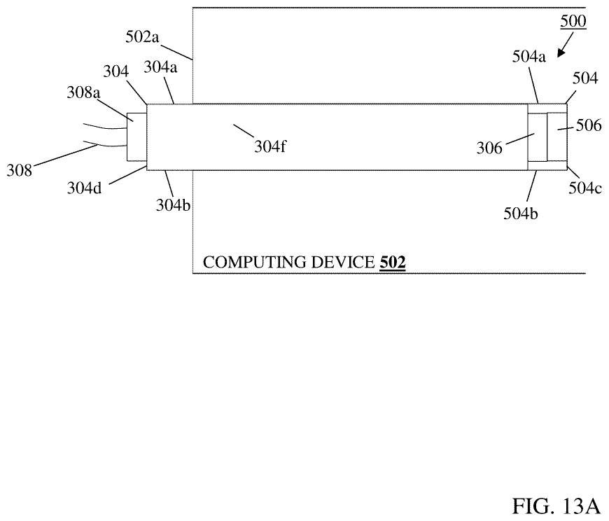

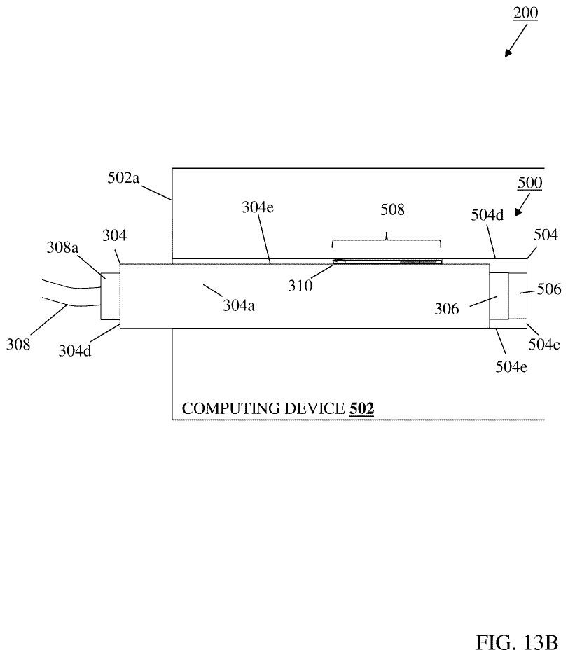

As illustrated in FIGS. 13A and 13B, the movement of the male cable connector subsystem 302 the securing distance into the female cable connector subsystem 500 and the prevention of the male cable connector subsystem 302 from being moved out of the female cable connector subsystem 500 discussed above results in the engagement of the male cable connector 306 on the male cable connector subsystem 302 and the female cable connector 506 on the female cable connector subsystem 500, and one of skill in the art in possession of the present disclosure will appreciate how any attempt to simply “pull” the male cable connector subsystem 302 out of the female cable connector subsystem 500 will be resisted by the engagement of the push/push securing element 310 on the male cable connector subsystem 302 and the push/push securing mechanism 508 on the female cable connector subsystem 500 as described above (i.e., unless a user first “pushes” the male cable connector subsystem 302 into the female cable connector subsystem 500 as described below). Following block 608, the computing device 502 may utilize the cable 308 on the male cable connector cabling system 300 (e.g., via the connection of the male cable connector 306 and the female cable connector 506) to transmit data. Thus, one of skill in the art in possession of the present disclosure will appreciate how blocks 604, 606, and 608 describe a first “push” of the male cable connector subsystem 302 into the female cable connector subsystem 500 that secures the male cable connector 306 in the female cable connector 506.

The method 600 then proceeds to decision block 610 where the method 600 proceeds depending on whether the male cable connector subsystem is moved from the secured orientation and a release distance into the female cable connector subsystem. In an embodiment, following the connection of the male cable connector subsystem 302 to the female cable connector subsystem 500 as described above, a user may wish to disconnect the male cable connector subsystem 302 from the female cable connection subsystem 500 for any of a variety of reasons that would be apparent to one of skill in the art in possession of the present disclosure, and may move the male cable connector subsystem 302 into the female cable connector subsystem 500 in order to do so. As such, in an embodiment of decision block 610, the method 600 may proceed depending on whether the male cable connector subsystem 302 is moved from the secured orientation and into the female cable connector subsystem 500 a release distance.

If, at decision block 610, the male cable connector subsystem is not moved from the secured orientation and the release distance into the female cable connector subsystem, the method 600 returns to block 608. As such, the method 600 may loop such that the push/push securing mechanism 508 on the female cable connector subsystem 500 continues to engage the push/push securing element 302 on the male cable connector subsystem 300 to secure the male cable connector subsystem 302 in the female cable connector subsystem 500 until the male cable connector subsystem 302 is moved from the secured orientation and into the female cable connector subsystem 500 the release distance.

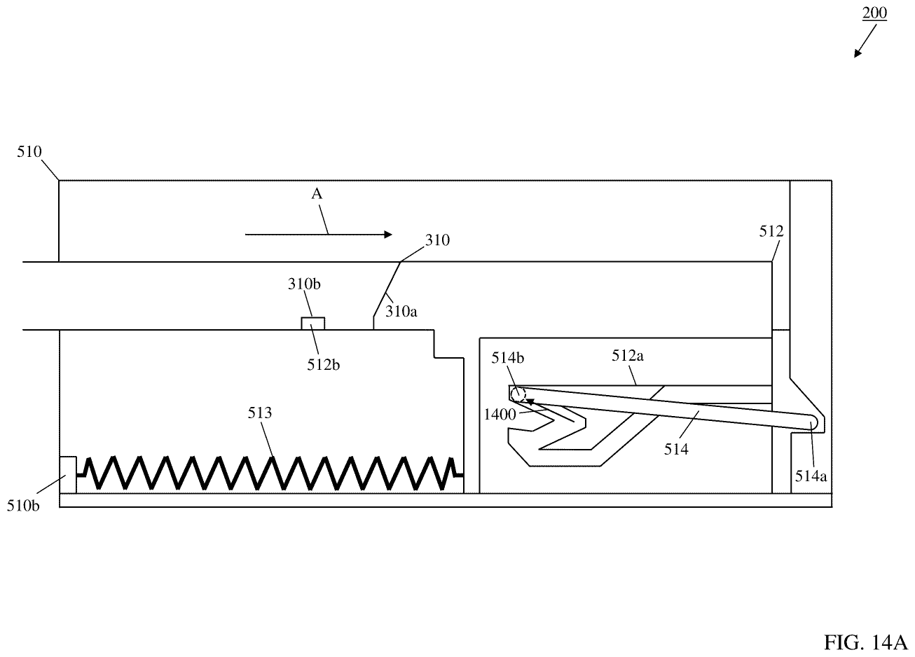

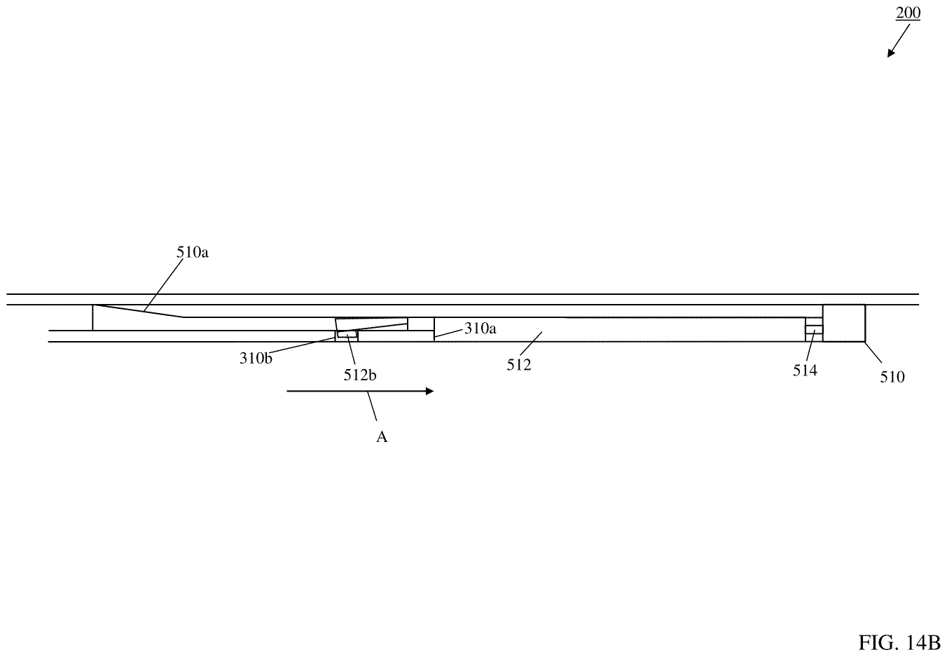

If, at decision block 610, the male cable connector subsystem is moved from the secured orientation and the release distance into the female cable connector subsystem, the method 600 proceeds to block 612 where the push/push securing mechanism on the female cable connector subsystem disengages the push/push securing element on the male cable connector subsystem to release the male cable connector subsystem from the female cable connector subsystem. With reference to FIGS. 14A and 14B, a user may move the male cable connector subsystem 302 from the secured orientation and in the direction A into the female cable connector subsystem 500, and the engagement of the push/push securing mechanism engagement surface 310a on the push/push securing element 310 with the slider element 512 on the push/push securing mechanism 508 will move the slider element 512 in the direction A when the force provided by the user on the male cable connector subsystem 302 and transferred to the slider element 512 via the push/push securing element 310 overcomes the force provided by the biasing element 513 on the slider element 512 (i.e., a spring that provides the biasing element 513 will expand and provide a force that is opposite the force of the push/push securing element 310 on the slider element 512 that moves the slider element 512 in the direction A).

As discussed above, in some embodiments the strength, stiffness, and/or other structure of the cable 308 (e.g., a DAC transceiver copper cable) may allow a user to move the male cable connector subsystem 302 in the direction A and into the female cable connector subsystem 500 using the cable 308 (e.g., a user may grasp the cable 308 without touching the male cable connector subsystem 302 and move the cable 308 to move the male cable connector subsystem 302 in the direction A and into the female cable connector subsystem 500) at block 602, which one of skill in the art in possession of the present disclosure will appreciate will prevent issues with users having to touch transceiver devices, which may be relatively hot due to their operation, in order to disconnect them from computing devices.

However, in other embodiments, the strength, stiffness, and/or other structure of the cable 308 (e.g., an SFP transceiver fiber optic cable) may not allow a user to move the male cable connector subsystem 302 in the direction A and into the female cable connector subsystem 500 using the cable 308 as described above, and a handle or other user engagement element (not illustrated) may extend from the cable connector base 304 (e.g., from the rear surface 304d) and may be grasped by a user to move the male cable connector subsystem 302 in the direction A and into the female cable connector subsystem 500, which one of skill in the art in possession of the present disclosure will also appreciate will prevent issues with users having to touch transceiver devices, which may be relatively hot due to their operation, in order to disconnect them from computing devices when their cables are not capable of supporting the forces needed to move them relative to the computing device to which they are connected.

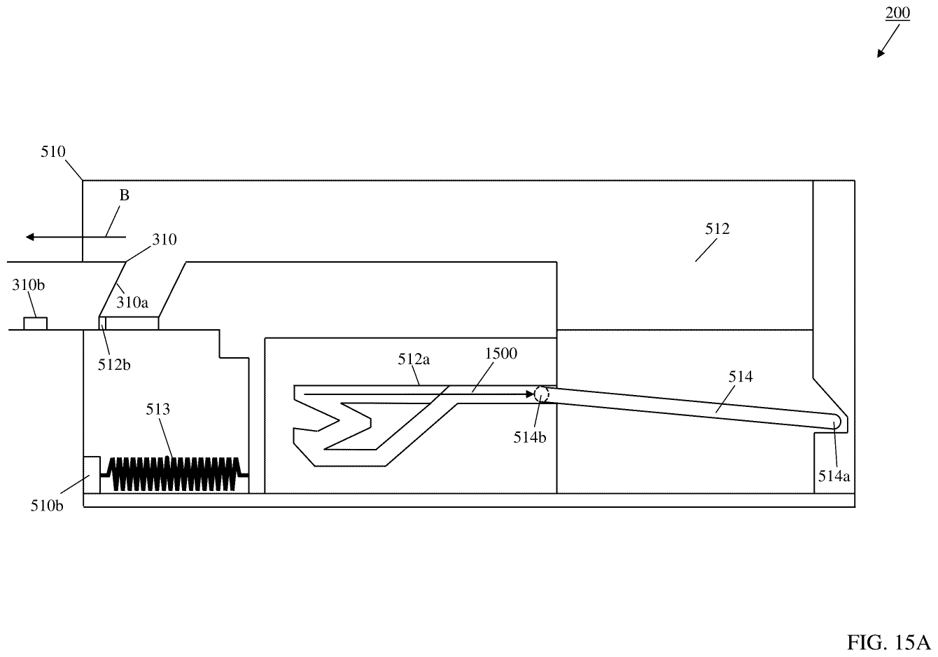

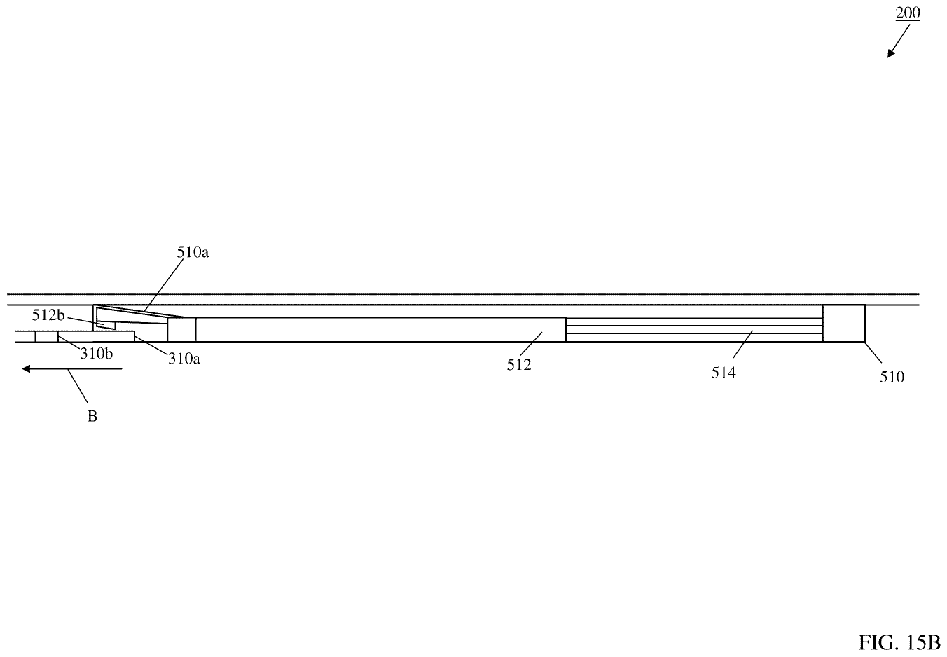

Furthermore, FIGS. 14A and 14B also illustrate how continued movement of the male cable connector subsystem 302 in the direction A that moves the slider element 512 in the direction A will cause the second end 514b of the rod element 514 to move through a fourth portion of the secure/release channel 512a defined by the slider element 512 (as illustrated by arrow 1400 in FIG. 14A) while the rod element 514 rotates about its first end 514a. The movement of the second end 514b of the rod element 514 through the fourth portion of the secure/release channel 512a illustrated in FIG. 14A positions the second end 514b of the rod element 514 in a release orientation in the secure/release channel 512a that corresponds to the release distance the male cable connector subsystem 302 has been moved into the female cable connector subsystem 500. As illustrated in FIGS. 15A and 15B, following the positioning of the second end 514b of the rod element 514 in the release orientation in the secure/release channel 512a and when the user subsequently no longer applies the force on the male cable connector subsystem 302 that overcame the force provided by the biasing element 513, the force provided by the biasing element 513 will move the slider element 512 in a direction B that will cause the second end 514b of the rod element 514 to move through a fifth portion of the secure/release channel 512a defined by the slider element 512 (as illustrated by arrow 1500 in FIG. 15A).

As can be seen in FIGS. 15A and 15B, the continued movement of the slider element 512 in the direction B will cause the push/push securing element connection member 512b on the slider element 512 to disengage the activation surface 510a on the base 510 of the push/push securing mechanism 508 and allow the push/push securing element connection member 512b to move out of the push/push securing mechanism connection aperture 310b defined by the push/push securing element 310. As will be appreciated by one of skill in the art in possession of the present disclosure, the removal of the push/push securing element connection member 512b on the slider element 512 from the push/push securing mechanism connection aperture 310b defined by the push/push securing element 310 will allow relative movement of the push/push securing element 310 and the slider element 512, and the continued movement of the male cable connector subsystem 302 in the direction B causes the push/push securing mechanism engagement surface 310a on the push/push securing element 310 to disengage the slider element 512 on the push/push securing mechanism 508, and releases the male cable connector subsystem 302 from the female cable connector subsystem 500.

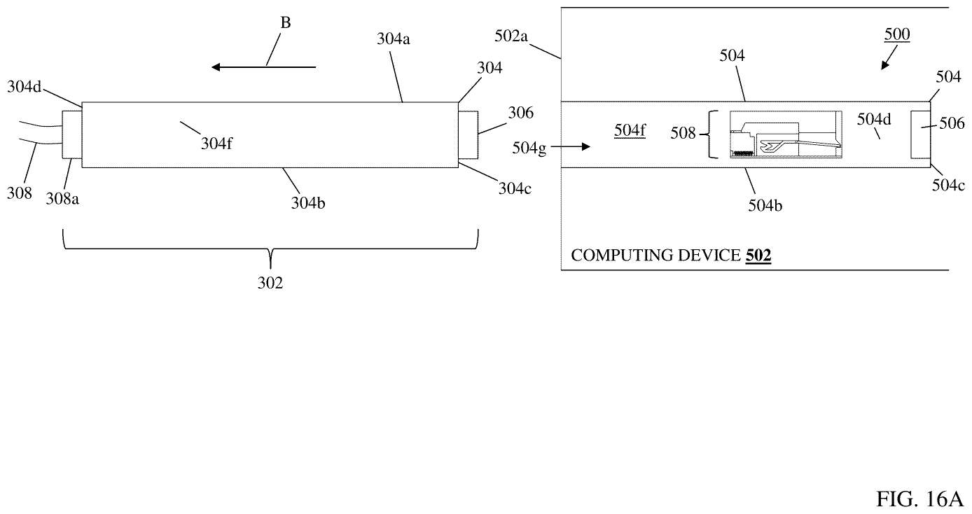

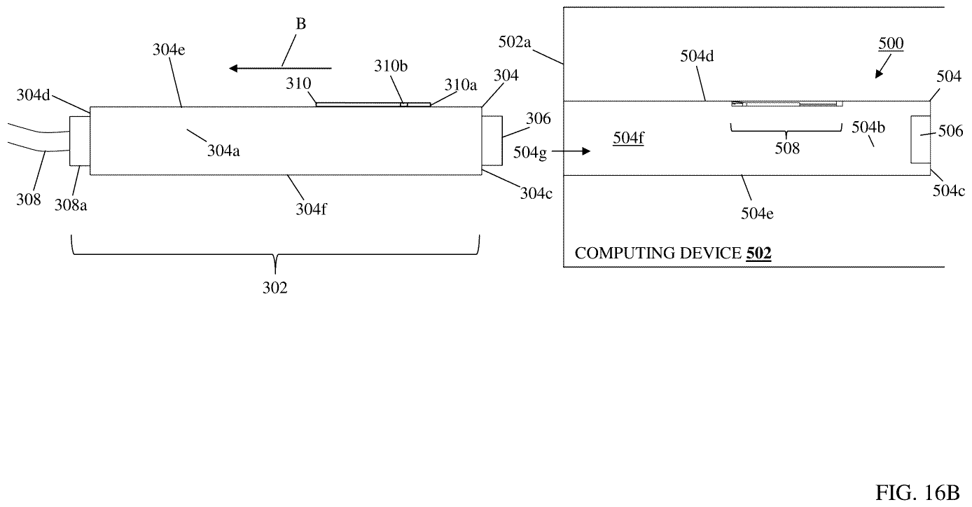

As illustrated in FIGS. 16A and 16B, the continued movement of the male cable connector subsystem 302 in the direction B following the release of the male cable connector subsystem 302 from the female cable connector subsystem 500 allows the male cable connector subsystem 302 to be removed from the female cable connector subsystem 500. Thus, one of skill in the art in possession of the present disclosure will appreciate how blocks 610 and 612 describe a second “push” of the male cable connector subsystem 302 into the female cable connector subsystem 500 that releases the male cable connector subsystem 302 from the female cable connector subsystem 500 (following the first “push” that secured the male cable connector 306 in the female cable connector 506 as discussed above) and allows the male cable connector 306 to be disconnected from the female cable connector 506 and the male cable connector subsystem 302 to be removed from the female cable connector subsystem 500.

Thus, systems and methods have been described that provide a male cable connector subsystem that may be pushed into a female cable connector subsystem to secure it to the female cable connector subsystem in a secured orientation, and then pushed into the female cable connector from the secured orientation to release it from the female cable connector subsystem. For example, the push/push male/female cable connector system of the present disclosure may include a male cable connector subsystem having a male cable connector, and a computing device having a female cable connector subsystem that includes a female cable connector and a push/push securing mechanism. The push/push securing mechanism on the female cable connector subsystem engages the male cable connector subsystem when it is moved a securing distance into the female cable connector subsystem, which secures the male cable connector subsystem in the female cable connector subsystem in a secured orientation in which the male cable connector is connected to the female cable connector. The push/push securing mechanism on the female cable connector subsystem disengages the male cable connector subsystem when it is moved from the secured orientation and a release distance into the female cable connector subsystem, which releases the male cable connector subsystem from the female cable connector subsystem. As such, the issues associated with the connection and disconnection of male cable connectors and female cable connectors discussed above are remedied.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A push/push male/female cable connector system, comprising:
a male cable connector subsystem that includes a male cable connector;
a computing device; and
a female cable connector subsystem that is included on the computing device and that includes a female cable connector and a push/push securing mechanism that is configured to:
engage the male cable connector subsystem when the male cable connector subsystem is moved a securing distance into the female cable connector subsystem to secure the male cable connector subsystem in the female cable connector subsystem in a secured orientation in which the male cable connector is connected to the female cable connector; and
disengage the male cable connector subsystem in response to the male cable connector subsystem being moved from the secured orientation and a release distance into the female cable connector subsystem to release the male cable connector subsystem from the female cable connector subsystem.

2. The system of claim 1, further comprising:
a cable that is integrated with and extends from the male cable connector subsystem.

3. The system of claim 2, wherein the male cable connector subsystem includes an 8 Position, 8 Contact (8P8C) male cable connector subsystem that is wired according to the RJ-45 standard.

4. The system of claim 1, wherein the male cable connector subsystem is a transceiver device.

5. The system of claim 1, wherein the female cable connector subsystem includes a plurality of inner walls that define a male cable connector subsystem housing, the push/push securing mechanism is included on a first inner wall included in the plurality of inner walls, and the male cable connector subsystem includes an outer surface having a push/push securing element that is configured to:
engage the push/push securing mechanism when the male cable connector subsystem is moved the securing distance into the male cable connector subsystem housing defined by the female cable connector subsystem; and
disengage the push/push securing mechanism in response to the male cable connector subsystem being moved from the secured orientation and the release distance into the male cable connector subsystem housing defined by the female cable connector subsystem.

6. The system of claim 1, wherein the push/push securing mechanism includes:
a base;
a slider element that defines a secure/release channel and that is configured to be engaged by the male cable connector subsystem and, in response, move relative to the base such that the slider element connects to the male cable connector subsystem to prevent relative movement between the slider element and the male cable connector subsystem;
a biasing element that resiliently biases the slider element against movement relative to the base in response to engagement with the male cable connector subsystem; and
a rod element that is rotatably coupled to the base at a first end, and that includes a second end that is located in the secure/release channel and that is configured to move through the secure/release channel to:
move into a securing portion of the secure/release channel when the male cable connector subsystem is moved the securing distance into the female cable connector subsystem; and
move out of the securing portion of the secure/release channel when the male cable connector subsystem is moved from the secured orientation and the release distance into the female cable connector subsystem.

7. The system of claim 1, further comprising:
a cable that is coupled to the male cable connector subsystem and that is configured to transfer a force on the cable to the male cable connector subsystem to move the male cable connector subsystem into the female cable connector subsystem.

8. A female cable connector subsystem, comprising:
a female cable connector chassis that is configured to mount to a computing device;
a female cable connector housing that is defined by the female cable connector chassis and that is configured to house a female cable connector; and
a push/push securing mechanism that is included on the female cable connector chassis and that is configured to:
engage a male cable connector subsystem when the male cable connector subsystem is moved a securing distance into the female cable connector chassis to secure the male cable connector subsystem in the female cable connector chassis in a secured orientation in which a male cable connector included on the male cable connector subsystem is connected to the female cable connector when the female cable connector is housed in the female cable connector chassis; and
disengage the male cable connector subsystem in response to the male cable connector subsystem being moved from the secured orientation and a release distance into the female cable connector chassis to release the male cable connector subsystem from the female cable connector chassis.

9. The female cable connector subsystem of claim 8, wherein the female cable connector chassis includes an 8 Position, 8 Contact (8P8C) female cable connector subsystem that is wired according to the RJ-45 standard.

10. The female cable connector subsystem of claim 8, wherein the female cable connector chassis is a transceiver cage.

11. The female cable connector subsystem of claim 8, wherein the female cable connector chassis includes a plurality of inner walls that define a male cable connector subsystem housing, and the push/push securing mechanism is included on a first inner wall included in the plurality of inner walls and is configured to:
engage a push/push securing element included on an outer surface of the male cable connector subsystem when the male cable connector subsystem is moved the securing distance into the female cable connector chassis; and
disengage the push/push securing element in response to the male cable connector subsystem being moved from the secured orientation and the release distance into the female cable connector chassis.

12. The female cable connector subsystem of claim 8, wherein the push/push securing mechanism includes:
a base;
a slider element that defines a secure/release channel and that is configured to be engaged by the male cable connector subsystem and, in response, move relative to the base such that the slider element connects to the male cable connector subsystem to prevent relative movement between the slider element and the male cable connector subsystem;
a biasing element that resiliently biases the slider element against movement relative to the base in response to engagement with the male cable connector subsystem; and
a rod element that is rotatably coupled to the base at a first end, and that includes a second end that is located in the secure/release channel and that is configured to move through the secure/release channel to:
move into a securing portion of the secure/release channel when the male cable connector subsystem is moved the securing distance into the female cable connector chassis; and
move out of the securing portion of the secure/release channel when the male cable connector subsystem is moved from the secured orientation and the release distance into the female cable connector chassis.

13. The female cable connector subsystem of claim 8, wherein the push/push securing mechanism is configured to:
generate a securing sound when the male cable connector subsystem is moved into the female cable connector chassis and provided in the secured orientation that secures the male cable connector subsystem in the female cable connector chassis.

14. A method for connecting a male cable connector and a female cable connector, comprising:
receiving, by a female cable connector subsystem that is included on a computing device, a male cable connector subsystem;
engaging, by the female cable connector subsystem in response to the male cable connector subsystem moving a securing distance into the female cable connector subsystem, the male cable connector subsystem to secure the male cable connector subsystem in the female cable connector subsystem in a secured orientation in which a male cable connector included on the male cable connector subsystem is connected to a female cable connector included on the female cable connector subsystem; and
disengaging, by the female cable connector subsystem in response to the male cable connector subsystem being moved from the secured orientation and a release distance into the female cable connector subsystem, the male cable connector subsystem to release the male cable connector subsystem from the female cable connector subsystem.

15. The method of claim 14, wherein a cable is integrated with and extends from the male cable connector subsystem.

16. The method of claim 15, wherein the male cable connector subsystem includes an 8 Position, 8 Contact (8P8C) male cable connector subsystem that is wired according to the RJ-45 standard.

17. The method of claim 14, wherein the male cable connector subsystem is a transceiver device.

18. The method of claim 14, wherein the female cable connector subsystem includes a plurality of inner walls that define a male cable connector subsystem housing, the push/push securing mechanism is included on a first inner wall included in the plurality of inner walls, the male cable connector subsystem includes an outer surface having a push/push securing element, and the method further comprises:
engaging, by the push/push securing element, the push/push securing mechanism when the male cable connector subsystem is moved the securing distance into the male cable connector subsystem housing defined by the female cable connector subsystem; and
disengaging, by the push/push securing element, the push/push securing mechanism in response to the male cable connector subsystem being moved from the secured orientation and the release distance into the male cable connector subsystem housing defined by the female cable connector subsystem.

19. The method of claim 14, wherein the push/push securing mechanism includes a base, a slider element that defines a secure/release channel, a biasing element that resiliently biases the slider element against movement relative to the base in response to engagement with the male cable connector subsystem, and a rod element that is rotatably coupled to the base at a first end and that includes a second end that is located in the secure/release channel, wherein the method further comprises:
engaging, by the slider element, with the male cable connector subsystem and, in response, moving relative to the base such that the slider element connects to the male cable connector subsystem to prevent relative movement between the slider element and the male cable connector subsystem;
moving, by the rod element, through the secure/release channel to:
move into a securing portion of the secure/release channel when the male cable connector subsystem is moved the securing distance into the female cable connector chassis; and
move out of the securing portion of the secure/release channel when the male cable connector subsystem is moved from the secured orientation and the release distance into the female cable connector chassis.

20. The method of claim 14, further comprising:
transferring, by a cable that is coupled to the male cable connector subsystem, a force on the cable to the male cable connector subsystem to move the male cable connector subsystem into the female cable connector subsystem.
